(19) United States
(12) Patent Application Publication
(10) Pub. No.: US 2005/0181352 A1
(43) Pub. Date: Aug. 18, 2005

(54) Printable fastener laminates for displays and play systems

(76) Inventors: William H. Shephard, Amherst, NH (US); George A. Provost, Litchfield, NH (US)

Correspondence Address: FISH & RICHARDSON PC, 225 FRANKLIN ST, BOSTON, MA, 02110, US

(21) Appl. No.: 11/062,274

(22) Filed: Feb. 18, 2005

Related U.S. Application Data
(63) Continuation of application No. PCT/US03/26070, filed on Aug. 20, 2003.
(60) Provisional application No. 60/404,722, filed on Aug. 20, 2002.

(51) Int. Cl. G09B 25/00

(52) U.S. Cl. 434/428

(57) ABSTRACT

A laminate comprising a paper substrate having at least one broad surface to which is laminated a light-weight hook-engageable material or a loop-engageable hook material. The hook-engageable material has a generally sheet-form web body having a first surface laminated to the broad surface of the substrate and a second surface over which hook-engageable fibers or yarns generally extend, the paper substrate having an adhesive material on its side opposite from the low-weight loop material. The laminate is configured to form play, educational or display systems comprising an extended display surface comprised of a first touch fastener surface and objects backed by a second touch fastener surface adapted to mate with the first touch fastener surface, with both the first and second touch fastener surfaces having laminated-sheet form backings.

### CROSS-REFERENCE TO RELATED APPLICATIONS

This application is filed under 35 U.S.C. § 111 as a continuation of PCT application U.S. 2003/026070, filed Aug. 20, 2003 designating the United States, and claiming priority under 35 U.S.C. §119(e) from U.S. Provisional Application Ser. No. 60/404,722, filed Aug. 20, 2002. The entire contents of these priority applications is hereby incorporated by reference in its entirety.

### BACKGROUND OF THE INVENTION

Not long after the advent of touch fastener materials, imaginative people anticipated their use in play and education products. Adjustable backgrounds and changeable attire for doll figures have been of particular interest. Examples of concepts like these include, e.g. the 1970 U.S. Pat. No. 4,045,897 and the 1990 U.S. Pat. No. 4,911,670.

Few products on the market have followed from the many proposals that appear in the literature. This may be because materials from which touch fastener systems have been made, and the techniques for integrating them into complete functional products, have been considered too expensive relative to cost constraints under which toy and educational product producers must operate. This has appeared to remain true despite efforts that have lowered the cost of fastener materials.

There has therefore been need for visually stimulating and attention-focusing displays and decorations, based on detachable fastening, which are versatile, effective, and low cost. Likewise there has been need for improved materials for fastening products and their methods of manufacture.

### SUMMARY OF THE INVENTION

One aspect of the invention features a play, educational or display system comprising an extended display surface comprised of a first touch fastener surface, and objects backed by a second touch fastener surface adapted to mate with the first touch fastener surface. Both the first and second touch fastener surfaces have paper backings. One of the first and second touch fastener surfaces comprises a loop material, and the other of the first and second touch fastener surfaces comprises an array of loop-engageable fastener elements with molded stems extending integrally from a base layer of resin encapsulating surface features of its paper backing.

In some embodiments, the molded stems carry loop-engageable heads of either molded or post-formed material. The backing on the back-side of the hook-defining material is preferably a printable surface carrying printing or adapted to receive user-applied color ink.

For some applications, the loop material is a low-weight material, weighing less than 4 ounces per square yard, preferably less than 2 ounces per square yard. In some cases, the loop material is in the form of a needled bat of fibers which, following needling, has been stretched and stabilized by a binder in the stretched condition, preferably of at least 20 percent areal stretch. Preferably the binder, at least in part, comprises a solidified binder applied in fluid form to the side of the loop-defining touch fastener material opposite from the side from which its hook-engageable loops extend. The non-woven material is, in some cases, a dye-printable medium which carries printing or is adapted to receive user-applied colored ink.

Preferably, the backing of at least one of the touch fasteners has an outside face carrying printing or is adapted to receive user-applied colored ink.

In some particularly useful configurations, the backing of at least one of the touch fastener surfaces with its touch fastener surface in place forms a printable material capable of passage through a printer, such as an ink jet printer. The backing of at least one of the touch fasteners can carry printing applied by a personal computer printer, for example.

Some illustrated embodiments are constructed for use in a play or educational system for a child participant, and include at least one three-dimensional action figure or object capable of a characteristic fanciful activity. The extended display surface includes a backdrop supporting and exposing to view a broad extent of the first touch fastener surface, and an assortment of visible objects in the form of stage props related to the activity of the action figure or object. Each of a set of these props is backed with the second touch fastener material, engageable with the first fastener material. The props of the set are of weight and size suitable to be attached to and supported by the backdrop, and are thereby adapted to be removably arranged and re-arranged on the backdrop to enable the participant to interact with the scene.

In some cases, the action figure is a doll, and the backdrop comprises panels of height scaled to the height of the doll, and arranged to receive the props in a realistic relationship to the doll in its characteristic activity. In some arrangements there are at least three panels in series that are flexibly secured to one another along respective common edges by folds in a continuous laminate of the paper and fastener material that define the panels. The panels are capable of being set up on a support surface at angles each to the other in a self supporting relationship for the panel assembly.

In some cases, the backdrop display comprises a set of panels formed by a backing paper that has been permanently doubled upon itself and laminated in the manner that portions of the first touch fastener material are disposed on both front and back-sides of the panels. Flexible hinge joints of adjacent panels may be formed solely by the laminated paper and first touch fastener material and adhesive material which joins them.

In some embodiments the system defines a set of panels constructed to be transportable with the scene set by the props in place, to enable placement on a desk, table or dresser, in “put away” state while still being exposed for view with the action figure.

In another example, the system is in the form of a sheet-form placemat system for a dog or cat. The placement includes the extended display surface, preferably with the first touch fastener material facing upwardly and preferably comprising hook-engageable loop material, and one or more objects appropriate for the pet (such as, for example, a water bowl, a place card with the pet's name, or an image of the pet or of an animal of the type of the pet) having the second touch fastener material, preferably comprising hooks engageable with the loop surface of the mat a result of cooperation of the backing with the loop material. The sheet-form placemat has lateral stiffness sufficient to not fold or buckle when subjected to normal pet activity.

In yet another example, the system is constructed in the form of a floor mat system, such as for placement beneath the chair of an infant or young child during a meal. The floor mat preferably comprises a composite of paper having laminated, on its upper surface, a covering of hook-engageable loop material as a first touch fastener material. The system also includes one or more objects appropriate for the infant or child, preferably having mating hooks engageable with the loop surface of the mat, as a result of cooperation of the backing with the first touch fastener. The sheet-form mat has lateral stiffness sufficient to not readily fold or buckle.

Another aspect of the invention features a method of displaying an image. The method includes generating the image in an electronic format within a computer, loading a printable medium into a home or office printer connected to the computer (the printable medium having a field of hook-engageable fastener loops or loop-engageable fastener hooks extending across a broad face thereof), printing the image directly onto the printable medium with the home-computer, and then displaying the image by releasably engaging the hook-engageable loops or engageable hooks with a field of complementary fastener elements on a supporting surface.

In some cases, the method includes cutting out an image or design from the printable medium along cut lines printed by the computer printer.

The supporting surface may be the backdrop of a play or educational system or a sheet-form placemat for a dog or cat pet, a sheet-form floor mat or an automobile head liner, for example. Other examples include the textile lining of the walls of office cubicles.

In some embodiments, the printable medium is printable paper laminated to a loop fastener component, the paper defining the printable surface, or printable paper laminated to the back of a field of miniature hooks capable of engaging in a loop fastener component, the paper defining the printable surface, or a printing surface on which reside low-lying hook-engageable loops, or an ultra low-weight non-woven material comprised essentially of needled fiber of about 3 denier, or a printing surface on which reside a dense array of small loop-engageable hooks, or a hook fastening member having on one side an array of hooks and on the opposite side a surface which is printable.

The inventors realize that a system of laminates employing (a) low-weight loop material as the loop element, preferably ultra low-weight loop material, (b) hook fasteners that are characterized by stems molded of resin continuously with a resin base layer, as the hook element, with these materials laminated to each other and to a paper-like backing such as conventional, low-cost Kraft paper, enables an unexpected cost breakthrough for the toy and educational product market mentioned above.

Ultra light-weight and apparently flimsy hook-engageable loop materials and in particular non-woven materials are found to be capable of functioning as hook-engageable fasteners while forming part of attractive displays and decorations. The products can be so low cost as to be disposable, and can be used or reused in many ways. Knitted materials of corresponding light weight can be similarly effective in certain circumstances.

Another aspect of the invention features a laminate comprising a paper substrate having at least one broad surface to which is laminated a layer of light-weight hook-engageable material having a basis weight of less than about 4 ounces per square yard, preferably about 2 ounces or less per square yard. The hook-engageable material has a generally sheet-form web body having a first surface laminated to the broad surface of the substrate and a second surface over which hook-engageable fibers or yarns generally extend, the paper substrate having an adhesive material on its side opposite from the low-weight loop material.

In some instances, a binder resin anchors the hook-engageable fibers or yarns and constitutes between about 20 and 40 percent of the weight of the material.

In some embodiments, the material comprises a stretched non-woven material, stabilized in its stretched condition.

In some other embodiments the hook-engageable material comprises a knit material in which yarns (including multi-filament yarns) form hook-engageable loops.

A graphic design may be printed upon a surface of the laminate and disposed to be visible by viewing the surface of the low-density web body from which the hook-engageable fibers or yarns extend. The graphic design may at least partially comprise printing residing on the hook-engageable fibers or yarns of the hook-engageable material, or on the surface of the web body from which the hook-engageable fibers or yarns extend, or on the opposite surface of the web body, or on the outer broad surface of the paper substrate, or on combinations of these surfaces.

In certain preferred cases the substrate comprises or is adhered to a corrugated core.

In preferred cases, the substrate is a smooth-sheet. A smooth paper sheet may be laminated at spaced-apart flutes of a core material.

The inventors realize that laminating paper to the back of the base layer of a molded hook can produce a significant benefit, in that the X-Y plane stability of the molded hook base can be greatly enhanced by such lamination. Even common, low-cost 85 pound Kraft paper, laminated in situ to the base layer of hook material being molded, for instance, renders a hook material much less pliable and distortable. When combined in a composite, excellent dimensional stability and strength in the X-Y plane is achieved with cost-effectively low amounts of resin. Even with such reduction, the X-Y stability obtained by the in situ paper laminate is also found to produce better properties for a hook product in many respects than are obtained with greater resin thickness.

Further, the absorbent and adherent properties of the unbonded side of the paper in the laminate is found to have great utility for the in situ laminate. By choice of a suitable grade of paper, the presence of the paper enables fine quality accurate printing. Such printing can be accomplished prior to introduction of the paper to laminating conditions. Likewise, it provides a printable surface for post-forming printing, even for printing of the hook laminate on a printer of a home computer. It has been found, for instance, that with an array of hooks of height of 0.015 inch or less, the paper backed laminate comprising, e.g., wallpaper-grade paper, can readily pass through a home computer printer, for instance the CANON™ Bubble Jet Printer, realizing desirable quality of images and graphics on the hook material. The laminate thus enables internet downloadable designs made accessible to customers by a sponsor for instance the dog placemat or the infant floor mat may be sponsored by dog food or baby food suppliers, as a form of advertising and internet download of designs which are cut from the material may be applied to personalize the effect.

The concepts disclosed herein are also useful for printing label information such as product codes, bar codes, instructions or warnings, for example.

Using the hook and loop product offers advantages of speed: once it is wrapped around a figure or product, it sticks to itself and is secure. Identification or design information can be printed on the hook or loop side of the product. Another advantageous feature is that the hook and the loop product can be reused. The hook and loop fastening is also not significantly affected by moisture, cold, oil, grease and other contaminants, and maintains good appearance and fastening strength after multiple openings and closings.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is an end view of a loop-paper laminate, and

FIG. 2 is a magnified view of a portion of the end view.

FIG. 3 is a plan view of the laminate of FIG. 1, folded along its long dimension.

FIG. 4 is a side view of the folded laminate of FIG. 3, and FIG. 5 is a magnified view of a portion of the side view.

FIG. 6 is a broken away perspective view of the laminate FIG. 4, folded about its vertical fold lines.

FIG. 7 is a photograph of a backdrop display, a selection of props, and an associated three-dimensional action figure, in disassembled condition.

FIG. 8 is a photograph of the materials of FIG. 7 as assembled for play.

FIG. 9 is a plan view of the assembly of FIG. 8.

FIG. 10 shows a similar backdrop display and props associated with a fashion designer, for play with an action figure.

FIG. 11 is a perspective view of a printable material comprising of paper and molded hooks, as a hook-paper laminate.

FIG. 12 illustrates printing on the laminate of FIG. 1 with a home computer system associated with an inkjet printer.

FIG. 13 shows a backdrop and props for play associated with a veterinarian action figure.

FIGS. 14 and 15 show the construction of the examination table prop shown in FIG. 13.

FIG. 16 is a photograph of a backdrop in the form of an extended horizontal surface, such as a floor, with a racetrack formed from printed hook-paper and loop-paper laminates.

FIG. 17 shows a pet feeding placemat, with bowls and decals.

FIG. 18 is an edge view of the placemat of FIG. 17.

FIG. 19 shows decals attached with hook fasteners to the headliner of the automobile.

FIG. 20 pictures a doll product in a package secured by a belt comprising a hook-loop laminate strip bearing decoration.

FIG. 21 pictures a doll secured within a package by printed hook-loop laminates formed into items of apparel, such as a belt and as a chest protector.

Like reference symbols in the various drawings indicate like elements.

### DETAILED DESCRIPTION

Paper-backed loop fastener components useful in the context of this invention can be fashioned according to the methods disclosed in PCT application number PCT/US00/14837, published as WO 00/73063. Paper can be laminated to non-woven loop materials formed by stretching needled fiber batts, such as those disclosed in U.S. Pat. No. 6,329,016. Such non-woven loop materials can be made of extremely low basis weight, the paper enhancing the X-Y stability of the loop material.

Paper-backed hook fastener tape can be formed by the methods taught by Kennedy et al. in U.S. Pat. No. 5,260,015, by introducing a continuous sheet of paper into a nip adjacent a cooled, rotating mold roller with inwardly extending, fixed, projection-forming cavities defined in its periphery. Molten plastic resin is also introduced to the exterior of the forming roller, along with the paper, for filling the cavities and forming a base in the manner that incorporates the paper on the side of the base opposite from the side in which the projections are formed. After cooling, the fastener material is withdrawn from the forming roller in a step that includes withdrawing the projections from the cavities. Acceptable hook shapes include the CFM-29 designation, available from Velcro U.S.A Inc. of Manchester, N.H., U.S.A., which is only 0.015 inch (0.38 mm) in height. Other molded hook shapes, and hooks with heads post-formed on molded stems, are also useful.

In this manner, the paper backing is laminated in situ with the hook material using a layer of resin that forms the base of the hook material to bond directly to the paper. The paper bonds intimately with the fastener element resin to become an integral part of the structure of the strip fastener, in what is termed an in situ lamination process, in which lamination occurs during forming the hooks, and resin of the base layer encapsulates surface features of the paper backing to form a relatively strong, permanent bond to the paper. Another example of in situ lamination is illustrated in U.S. Pat. No. 5,441,687, Murasaki et al. In some examples of in situ lamination, the loop material is introduced later but while the hooks are still in their protected position within their mold cavities. In such cases supplemental surface heat may be applied to the resin just prior to application of the loop material by a pressure roll.

The paper, prior to lamination to the hook base resin, may receive pre-applied layers of important materials that are incompatible with the resin of which the hooks are being formed. For instance, a polyethylene coated or laminated film may be pre-applied to the paper to pre-rid moisture resistance to the backside of the product, and provide a desired vapor barrier. Similarly, a cushioning layer of, for instance, plastic foam may be applied to the backside of the paper, despite incompatibility of the resin of the foam with the resin of which the fasteners are being molded.

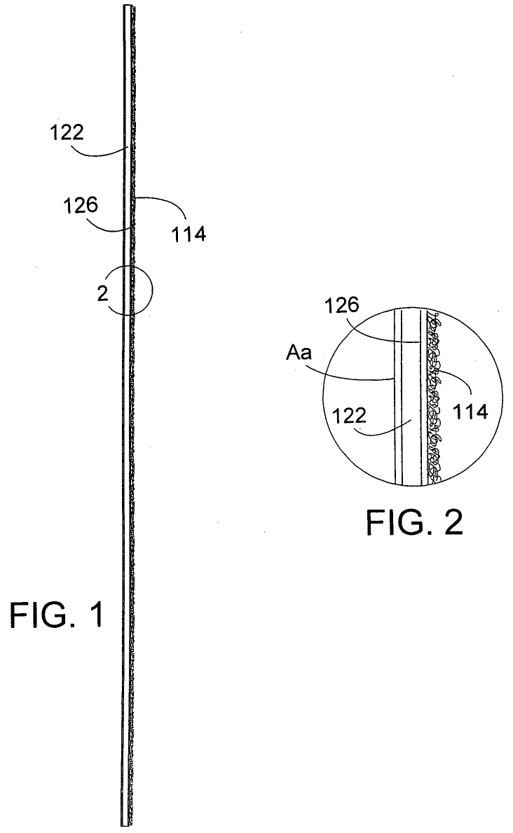

Referring to FIGS. 1-6, a backdrop BD is formed from a loop-paper laminate shown in FIG. 1. It comprises on one face continuous non-woven hook-engageable loop material of low-weight 114 and on its opposite side continuous paper 122 which is laminated uniformly to the reverse side of the non-woven material 114 with bonding adhesive 126. As shown in the end-view of FIG. 1 and the magnified of FIG. 2, the loop material 114 stands above the surface providing hook-engageable loops. The extent is very slight as described above. The loop-paper laminate has a length L in one embodiment of 24 inches and a width W of 22 inches. A first fold line is established at half the width for purposes to be described. At the back of the paper 122 is an activatable adhesive Aₐ.

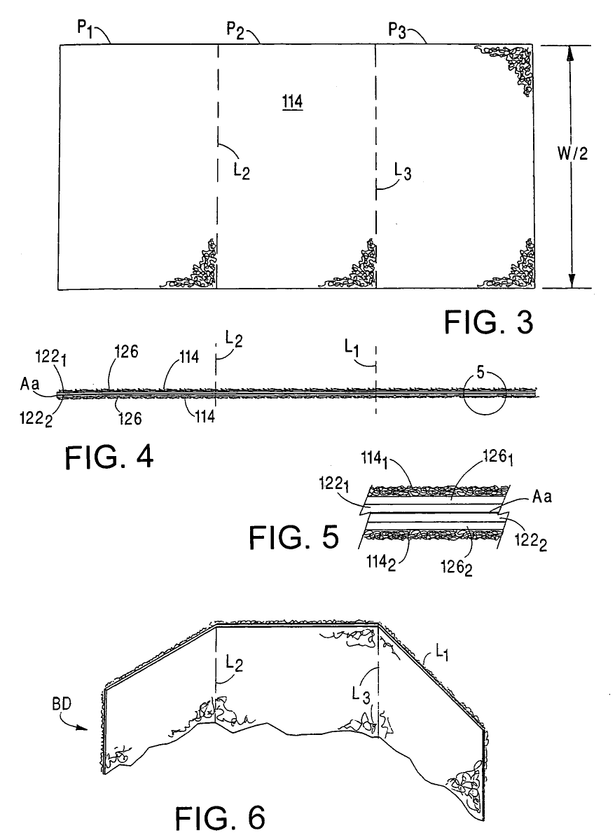

Referring to FIG. 3, the laminate is folded along first fold line L₁ to establish a height W/2 of the backdrop of about 11 inches. Two additional fold lines 2,3 are placed at ⅓ intervals along the length. At the time of folding, the activatable adhesive Aₐ is activated and pressure is applied to bond the two folded sides together, thus providing a thickness comprising two layers 122₁ and 122₂ of the paper, the joining adhesive between those layers Aₐ and the continuous low-weight hook-engageable loop material 114, presenting its hook-engageable loops to the outside surfaces of both front and back of the unit. The unit is then folded on lines L₂ and L₃ to the self-supporting form shown in FIG. 6. They also can be folded entirely down upon the middle panel and a fastener strapped hook may engage the two loose edges to bind them together and form a portfolio.

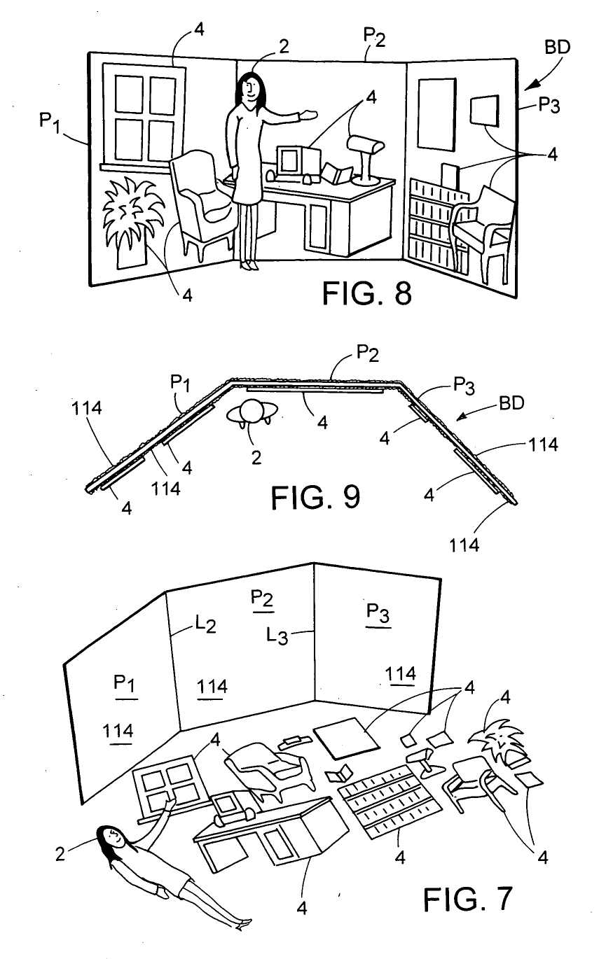

FIGS. 7-9 show a lawyer's office arrangement employing the backdrop BD with its panels P₁, P₂ and P₃. In the example shown, the hook-engageable loop is not printed but rather presented in its raw form, presenting a pleasantly neutral backdrop. A set of props is provided in the form of decals, each in this case comprising hook material formed of hooks and a base layer of resin as previously described. The hooks are of a shallow height and suitable to engage the loops of the low-weight hook-engageable loop material 114. The props 4 are independent decals formed of wallpaper grade paper and printed or hand colored with ink markers as shown. Their three-dimensional configuration along with the bent free panels that simulate a room provide a realistic background for the action FIG. 2, in this case a lawyer in her office.

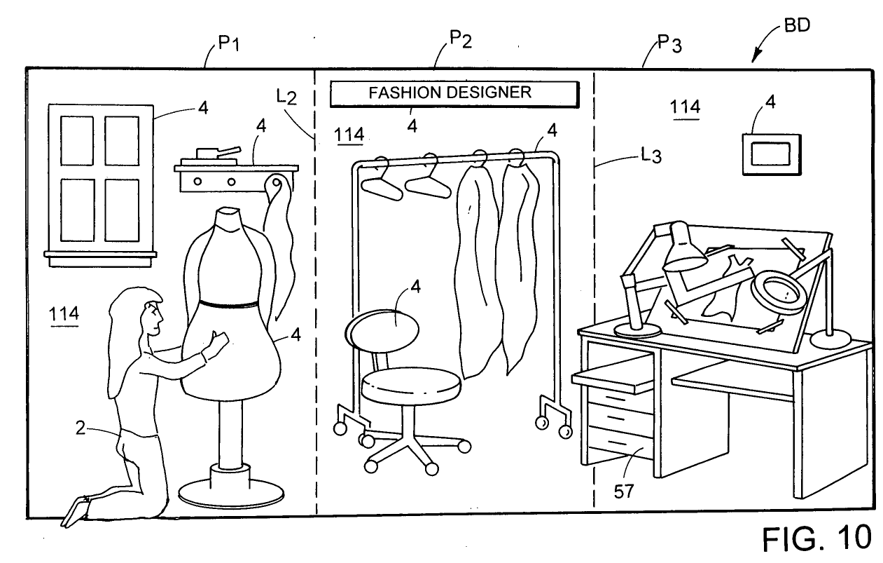

Referring now to FIG. 10, a fashion designer 2 is shown in her studio with the decal props similar to those of FIG. 8. The same backdrop BD is a three-panel member formed by the folded paper laminate shown in FIG. 1. It is worthy of note that the panels P₁, P₂ and P₃ folding about the fold lines L₂ and L₃ are self-hinging in that the paper and the outer layers of bonded non-woven provide strengthened flex regions that can be repeatedly folded without harm. The construction of the decal items 4 are as before comprised of hook elements molded to a plastic resinous base layer and joined by adhesive to a continuous paper of printable ink receiving nature. Whereas the backdrop and the props may be supplied as a set, the provision is also made for adding additional items.

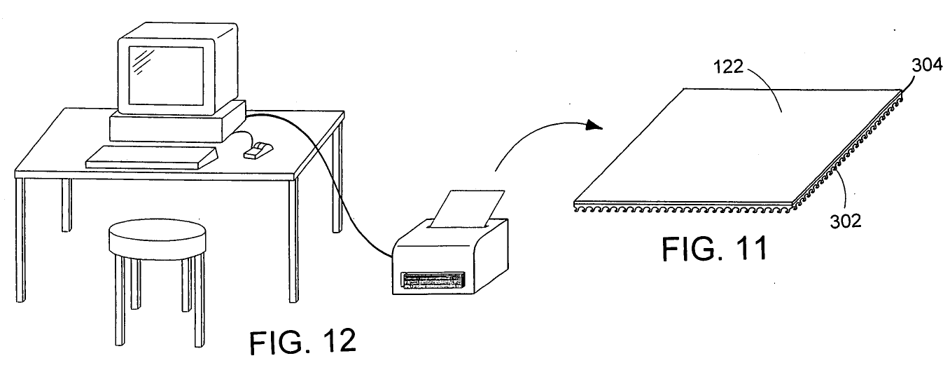

FIG. 11 shows a sheet of printable paper 122 integrally laminated to a base layer 304 of resin from which an array of fastener elements 302 extend from an opposite side. This laminate product can be formed by the in situ lamination methods discussed above.

Referring to FIG. 12 a home computer is pictured communicating with the internet and outputting to a home ink jet printer suitable for working with a home computer such as a desktop PC or a laptop computer. Importantly, the laminate of the paper 122 and the hook material 302 and 304 is readily printable in that it can be fed directly through the paper feeding mechanism of a typical home printer, such as an ink jet printer. By internet connection with a toy maker or with a friend, a new design, for instance a new dress design for use with the dress designer prop set shown in FIG. 10, may be communicated to the user and downloaded by his or her computer, printed on the ink jet printer. The image may provide cut-out lines by which standard scissors may be employed to cut the material and make a new decal to customize the set of props according to the wishes of the user.

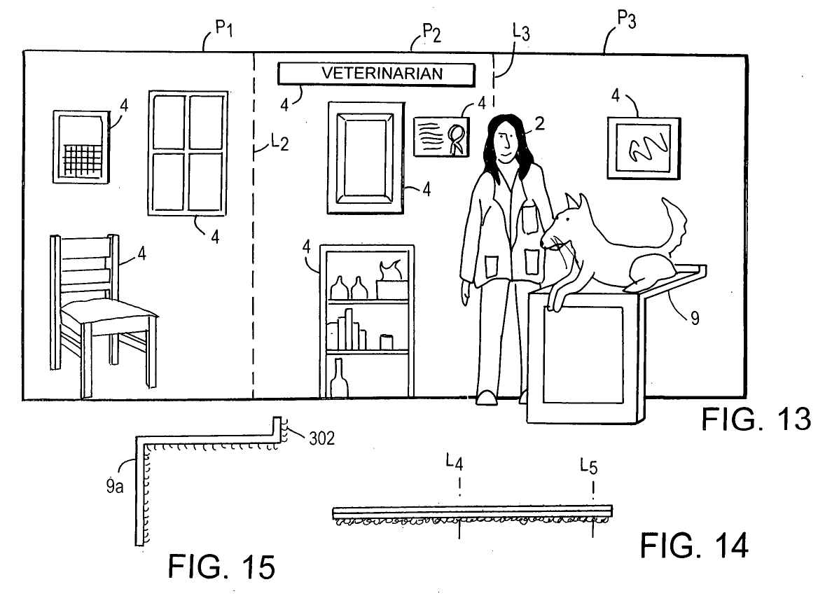

FIG. 13 shows an action FIG. 2 with a backdrop BD as previously described, in this case a veterinarian in her office. An examination table 9 is formed as shown in FIGS. 14 and 15, by folding a hook-paper laminate prop at fold lines L₄ and L₅. When folded about these lines in the manner shown in FIG. 15, the hooks on the small flange to the right of the examination table are disposed to engage the loop of the panel P₃ while the lower leg 9a of the examination table rests on the surface on which the backdrop is placed, in order to support a three-dimensional figure of an animal.

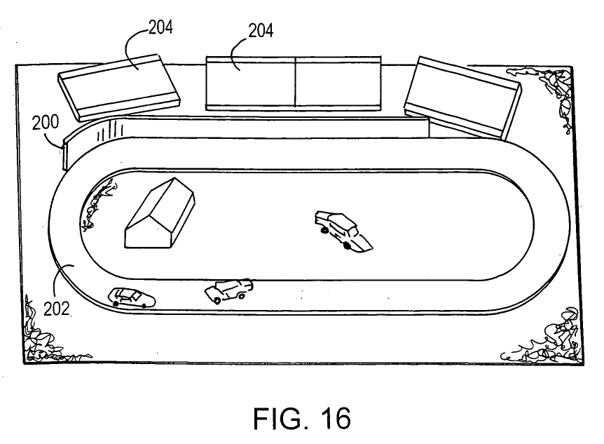

Referring now to FIG. 16, the backdrop in this case is a background loop material laminated to paper in a way previously described to provide a stable floor support system. In other cases the backdrop may be the carpet on the floor. Mounted on that background is hook-paper laminate material forming a racetrack 202, formed as discussed above. The hooks engage the background loop material or the carpet to firmly secure the racetrack in the form desired. The racetrack material may be supplied in sheets and cut to the form of the desired track. Along the edge of the racetrack is formed a rail 200 comprised of the loop-paper laminate previously described. The loop material is formed on both the outside and the inside of the rail due to folding in the manner previously described. Ads similar to those found on real racetracks are attached in the form of decals to the inside of the rail. Ads like this can be downloaded from the internet by computer. Bleachers 204 are formed from printed hook-paper or loop-paper laminate, which can be printed with an actual photograph of a racetrack crowd, for example. The laminate may be cut and folded to form a self-standing structure. The upper surface of the bleacher may be accordion-folded to give the crowd a more realistic appearance.

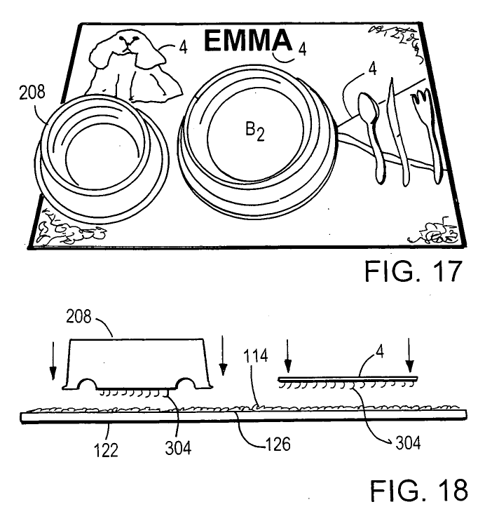

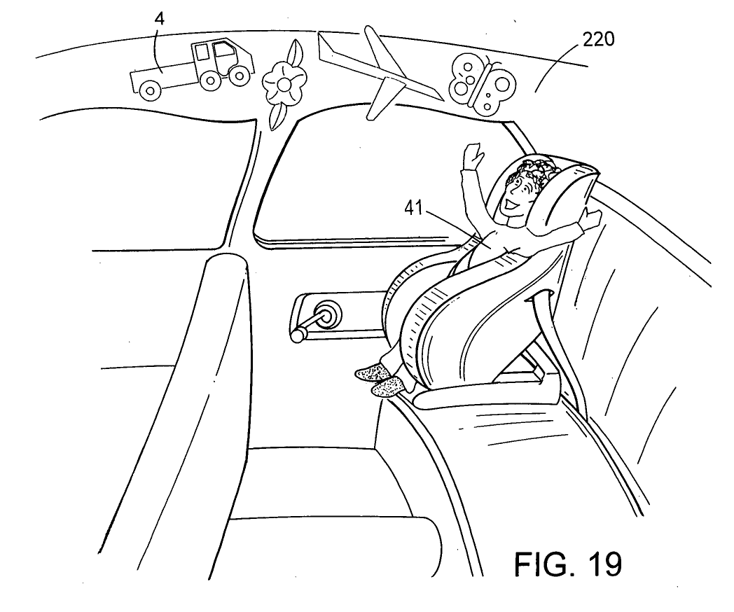

Referring to FIGS. 17 and 18, a pet place mat comprises a loop-paper laminate as discussed above. The paper 122 is joined to the loop material 114 by adhesive 126. The materials cooperate to provide significant dimensional stability in the X-Y plane, such that any disturbing motions of the place mat tends to push the place mat aside but not to wrinkle it or upset anything resting upon it. Decals 4 comprise hook-paper laminate that releasably engages the loop surface of the mat. A bowl 208 placed upon the pet place mat has integrally molded, downwardly extending hooks 304 that engage loops of the loop material 114.

A pet company may communicate a design to a home owner or pet owner. For instance, the company may formulate a name plate and a depiction of the pet, which in fact could be a photograph of a pet. This image may be downloaded over the internet by a computer to be printed upon a home ink jet printer, as discussed above, onto the paper surface 122 of the hook-paper laminate.

FIG. 19 illustrates decals 4 releasably applied to a non-woven headliner of a passenger vehicle. Such decals may be drawn by a homeowner on his computer, or obtained from friends or other sources via the internet, printed on the hook-paper laminate material described above, cut out and made available to an infant or young child for their attention and entertainment during driving.

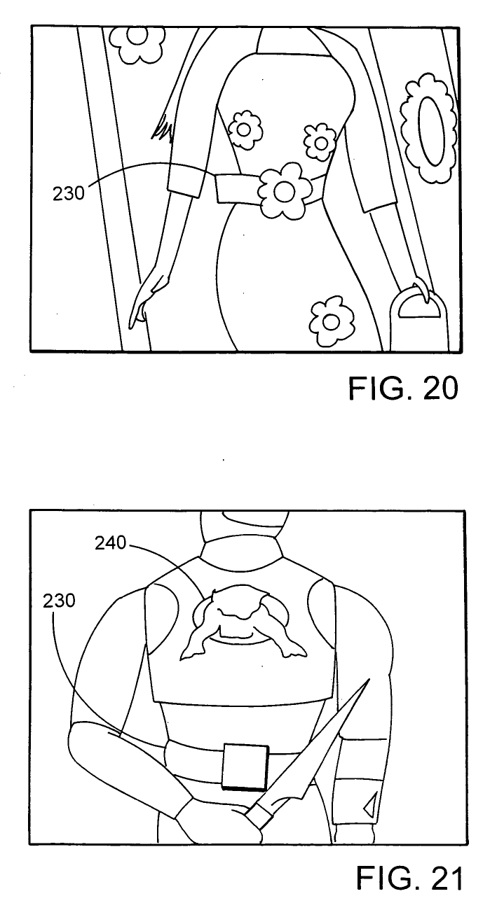

FIGS. 20 and 21 illustrate the use of hook-loop laminates, such as made by the process described in Kennedy et al., U.S. Pat. No. 5,260,015, to secure objects (in these examples, dolls) in packaging. Such laminates can be printed on either the hook side or loop side of the material. In the example shown in FIG. 20, the hook side of a strip-form laminate is printed in a decorative belt form, and the belt 230 is threaded through openings in the package insert and secured, thus securing the doll in its package for sale. It is thus an advantage that the belt serves a packaging function as well as a decorative function for the presentation for sale, and eventually a useful prop for the play activity. In the example of FIG. 21, both a belt 230 and a shirt 240 are provided. Shirt 240 has extensions (not shown) which are passed through openings in the package insert and secured.

Further details on the above-described materials and their methods of manufacture are disclosed in U.S. Pat. Nos. 6,342,285, 6,329,016 and 6,035,498, PCT Application Nos. PCT/US98/18401, PCT/US00/14837 and PCT/US01/13752, and U.S. patent application Ser. Nos. 09/133,991, 09/332,663, 10/125,679 and 08/922,292. Each and every U.S. and PCT patent application and issued U.S. patent referred to above is hereby incorporated by reference.

Other embodiments will be apparent and will fall within the scope of the following claims:

1. A display system comprising an extended display surface comprised of a first touch fastener surface, and objects backed by a second touch fastener surface adapted to mate with the first touch fastener surface; wherein both the first and second touch fastener surfaces have paper backings; and wherein one of the first and second touch fastener surfaces comprises a loop material, and the other of the first and second touch fastener surfaces comprises an array of loop-engageable fastener elements with molded stems extending integrally from a base layer of resin encapsulating surface features of its paper backing.

2. The system of claim 1 in which said molded stems carry loop-engageable heads of molded material.

3. The system of claim 1 in which the backing of the hook-defining material has a printable surface carrying printing or adapted to receive user-applied color ink.

4. The system of claim 1 in which said loop material comprises low-weight material weighing less than 4 ounces per square yard.

5. The system of claim 1 in which said hook-engageable loop material comprises a non-woven material stabilized by a binder in a stretched state.

6. The system of claim 5 in which the non-woven material comprises a dye-printable medium which carries printing or is adapted to receive user-applied colored ink.

7. The system of claim 1 in which the paper backing of at least one of said touch fastener surfaces, together with its touch fastener surface, forms a printable material capable of passage through a printer.

8. The system of claim 7 in which the paper backing of at least one of the touch fastener surfaces carries printing applied by a personal computer printer.

9. The system of claim 1 in which the paper backing of one of said touch fasteners is adapted to be printed by ink jet printing.

10. The system of claim 1 constructed for use in a play or educational system for a child participant and including at least one three-dimensional action figure capable of a characteristic fanciful activity, said extended display surface comprising a backdrop supporting and exposing to view a broad extent of said first touch fastener surface, and an assortment of visible objects in the form of stage props related to the fanciful activity of the action figure, each of a set of these props being backed with said second touch fastener material that is engageable with the first fastener material, the props of the set being of weight and size suitable to be attached to and supported by the backdrop, the props thereby adapted to be removably arranged and re-arranged on the backdrop by the participant to alter a scene.

11. The system of claim 10 in which there are at least three panels in series that are flexibly secured to one another along respective common edges by folds in a continuous laminate of said paper and fastener material that define the panels, the panels capable of being set up on a support surface at angles each to the other in a self supporting relationship for the panel assembly.

12. The system of claim 10 in which said backdrop display comprises a set of panels formed by a backing paper that has been permanently doubled upon itself and laminated in the manner that portions of said first touch fastener material are disposed on both front and back sides of the panels.

13. The system of claim 12 in which flexible hinge joints of adjacent panels are formed solely by the laminated paper and first touch fastener material and adhesive material which joins them.

14. The system of claim 1 in the form of a sheet-form placemat system for a dog or cat, the placement comprising said extended display surface, with the first touch fastener material facing upwardly, and one or more objects appropriate for the pet having the second touch fastener material, the sheet-form placemat having lateral stiffness sufficient to not fold or buckle when subjected to normal pet activity.

15. The system of claim 1 constructed in the form of a floor mat system for placement beneath a chair of an infant or young child during a meal, the floor mat preferably comprising a composite of paper having laminated, on its upper surface, a covering of hook-engageable loop material as a first touch fastener material, and said object being one or more objects appropriate for the infant or child, the sheet-form mat having lateral stiffness sufficient to not readily fold or buckle.

16. The system of claim 1 in which at least some of said objects carry a pattern or image downloaded from a sponsoring source of the system, of form printed by a computer printer local to the user.

17. The system of claim 1 in which the object has edges separated from a larger sheet of material according to a pattern or image printed on the material.

18. A method of displaying an image, comprising;
generating the image in an electronic format within a computer;
loading a printable medium into a home or office printer, the printable medium having a field of hook-engageable fastener loops or loop-engageable fastener hooks extending across a broad face thereof;
printing the image directly onto the printable medium with the home-computer; and then
displaying the image by releasably engaging the hook-engageable loops or engageable hooks with a field of complementary fastener elements on a supporting surface.

19. The method of claim 18 including cutting out an image or design from the printable medium along cut lines printed by the computer printer.

20. The method of claim 18 in which the supporting surface is a backdrop of a play or educational system or a sheet-form placemat for a dog or cat pet, a sheet-form floor mat or an automobile head liner.

21. The method of claim 18 in which the printable medium is printable paper laminated to a loop fastener component, the paper defining the printable surface.

22. The method of claim 18 in which the printable medium is printable paper laminated to a back of a field of miniature hooks capable of engaging a loop fastener component, the paper defining the printable surface.

23. The method of claim 18 in which the supporting surface is floor carpet or a textile wall covering.
